(19) United States
(12) Patent Application Publication
(10) Pub. No.: US 2025/0061337 A1
(43) Pub. Date: Feb. 20, 2025

(54) METHOD AND APPARATUS FOR TRAINING ARTIFICIAL INTELLIGENCE MODEL FOR SELF-SENSING ACTUATOR

(71) Applicants: Electronics and Telecommunications Research Institute, Daejeon (KR); Sookmyung Women's university industry-academic cooperation foundation, Seoul (KR)

(72) Inventors: Han Vit KIM, Daejeon (KR); Joo Yong SIM, Suwon-si (KR); Jeong Won PARK, Seoul (KR); Jun Chang YANG, Seoul (KR); Gia JEONG, Seoul (KR); Chul HUH, Daejeon (KR)

(21) Appl. No.: 18/806,637

(22) Filed: Aug. 15, 2024

(30) Foreign Application Priority Data
Aug. 17, 2023 (KR) 10-2023-0107643

(51) Int. Cl. G06N 3/09; H02N 10/00

(52) U.S. Cl. CPC G06N 3/09; H02N 10/00

(57) ABSTRACT

In an apparatus and method for training artificial intelligence model for self-sensing actuator, the method includes acquiring a dataset from a shape memory alloy system by changing control parameters for controlling the shape memory alloy system, classifying the dataset into input data and ground truth data and labeling the dataset based on the ground truth data, and performing supervised training on the artificial intelligence model using the labeled dataset so that the artificial intelligence model outputs a generated force of a shape memory alloy with a specific shape or a length change of the shape memory alloy with the specific shape from the input data.

### CROSS-REFERENCE TO RELATED APPLICATIONS

This application is based on, and claims priority to, Korean Patent Application Number 10-2023-0107643, filed on Aug. 17, 2023, the disclosure of which is incorporated by reference herein in its entirety.

### TECHNICAL FIELD

The present disclosure relates to a method and an apparatus for training an artificial intelligence model. More specifically, the present disclosure relates to a method and an apparatus for training an artificial intelligence model for self-sensing soft actuator.

### BACKGROUND

The content described below simply provides background information related to the present embodiment and does not constitute the prior art.

A shape memory alloy (SMA) refers to an alloy that can be deformed within a predetermined deformation range but returns to its original shape when heated beyond a specific temperature.

SMAs may exist in the austenite phase at high temperatures and in the martensite phase at low temperatures. SMAs change their shape by a phase transformation between the austenite and martensite according to temperature. The shape change of SMA is sensitive to temperature. Therefore, the force and strain of SMA change sensitively to the surrounding environment or the conditions of an applied current. In this regard, the control of an SMA is considered difficult. To alleviate the situation, research is being carried out to investigate variations in the impedance value and overall shape due to the phase transformation of SMAs.

A soft actuator made using SMA exhibits enhanced control efficiency as the total length and the generated force of the actuator are determined accurately in real-time. Therefore, a sensor is required to measure the overall length and force of the actuator. However, considering the nature of soft actuators, where output efficiency is improved as the generated force relative to the total system weight increases, the actuator's performance degrades when an external sensor is attached. Therefore, a method is required, which may sense changes in length of the actuator and forces generated by the actuator while minimizing the number of attached sensors.

### SUMMARY

Various aspects of the present disclosure are directed to providing an apparatus and method for training artificial intelligence model for self-sensing actuator.

The exemplary embodiments of the present disclosure provides an actuator capable of self-sensing changes in length of a shape memory alloy (SMA) and generated forces in real-time while minimizing the number of externally attached sensors.

The exemplary embodiments of the present disclosure provides a method for training an artificial intelligence model capable of predicting the changes in length of a shape memory alloy and forces generated by the actuator from impedance and temperature.

The purposes of the present disclosure are not limited to those mentioned above, and other purposes not mentioned herein will be clearly understood by those skilled in the art from the following description.

According to at least an exemplary embodiment of the present disclosure, the present disclosure provides a computer implemented method for training an artificial intelligence model for self-sensing of an actuator, including acquiring a dataset from a shape memory alloy system by changing control parameters for controlling the shape memory alloy system, classifying the dataset into input data and ground truth data and labeling the dataset based on the ground truth data, and performing supervised training on the artificial intelligence model using the labeled dataset so that the artificial intelligence model outputs a generated force of a shape memory alloy with a specific shape or a length change of the shape memory alloy with the specific shape from the input data, wherein the shape memory alloy system includes wire and the shape memory alloy with the specific shape.

According to another exemplary embodiment of the present disclosure, the present disclosure provide a self-sensing actuator including an actuator, a control unit configured to control the actuator, and a calculating unit configured to receive data from the control unit and the actuator, and calculate at least one of a generated force of the actuator and a length change of the actuator, wherein the calculating unit includes an artificial intelligence model trained by a method of any one of claims 1 to 6.

According to various exemplary embodiments of the present disclosure, it is possible to provide an actuator capable of self-sensing changes in length of a shape memory alloy (SMA) and a force generated from the SMA in real-time by using a trained artificial intelligence model while minimizing the number of externally attached sensors.

According to various exemplary embodiments of the present disclosure, it is possible to provide a method for training an artificial intelligence model capable of predicting the changes in the SMA's length and the generated force of the actuator from impedance and temperature.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is a block diagram briefly illustrating an apparatus for training an artificial intelligence model according to one embodiment of the present disclosure.

FIG. 2 is a flow diagram illustrating a process of training an artificial intelligence model according to one embodiment of the present disclosure.

FIG. 3 is a block diagram briefly illustrating a self-sensing actuator according to one embodiment of the present disclosure.

FIG. 4 is a flow diagram illustrating a self-sensing process of an actuator using a trained artificial intelligence model according to one embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

A singular expression used in the subsequent description may include a plural expression unless clearly indicated otherwise.

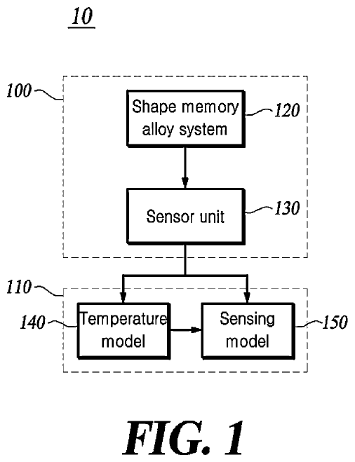

FIG. 1 is a block diagram briefly illustrating an apparatus for training an artificial intelligence model according to one embodiment of the present disclosure.

The constituting elements of FIG. 1 represent functionally distinct elements, where at least one or more constituting elements may be implemented in an integrated form in an actual physical environment.

Referring to FIG. 1, an artificial intelligence model training apparatus 10 includes a data acquisition unit 100 and at least one or more artificial intelligence models 110.

The data acquisition unit 100 may include a sensor unit 130 and a SMA system 120.

The data acquisition unit 100 acquires a dataset for training the artificial intelligence model 110. The dataset acquired by the data acquisition unit 100 may include control parameters of the SMA system 120, measured voltages of the SMA system 120 and corresponding ground truth data. The control parameters include load limit, input current and operation time which may be randomly chosen in a given range. The corresponding groud truth data includes forces generated by the SMA system 120, temperatures of the SMA system 120 and strain of the SMA system 120. The strain of the SMA system 120 may refer to the change in length of the SMA system 120.

The data acquisition unit 100 may control the control parameters. The control parameters may further include frequency of AC voltage. The data acquisition unit 100 may independently control each of the control parameters. The data acquisition unit 100 may control each of the control parameters within a predetermined range. For example, the data acquisition unit 100 may control the control parameters by setting the current and operation time to maximum values while setting the load limit to the minimum. The data acquisition unit 100 may control the control parameters to have random values. In other words, the data acquisition unit 100 may randomly control each control parameter within a predetermined range. The predetermined range may be set by a user. The predetermined range may be set differently for each control parameter.

The SMA system 120 includes all or part of a SMA with a specific shape, a wire and a load cell.

The SMA with a specific shape may have various shapes. For example, the SMA system 120 may include an SMA having at least one of zigzag shape, woven shape, and spring shape; the SMA is not limited to a specific shape but may assume various shapes. The SMA with a specific shape may be the same SMA included in the self-sensing actuator 30. The wire may be made of the same material as the SMA with a specific shape.

The wire of the SMA system 120 is configured so that its length does not change or changes only slightly even when an external force is applied. Therefore, the length of the wire changes only due to changes in temperature and the ratio of austenite and martensite of the SMA. In other words, by measuring the resistance or impedance of the wire and using the measured value for prediction, the length change of the SMA due to temperature and characteristics of the SMA may be reflected in the artificial intelligence model. For example, the characteristics of the SMA may represent the characteristics due to the alloy ratio of the SMA.

The sensor unit 130 may measure a current, a voltage across the SMA with the specific shape, a voltage across the wire, a length change of the SMA with the specific shape, a generated force of the SMA with the specific shape, a temperature and an operation time.

The sensor unit 130 may calculate the resistance or impedance of the wire using the current flowing through the SMA system 120 and the voltage across the wire. The sensor unit 130 may calculate the resistance or impedance of the SMA with the specific shape using the current flowing through the SMA system 120 and the voltage across the SMA with the specific shape.

The data acquisition unit 100 may label a temperature, a generated force of the SMA with the specific shape, a length change of the SMA with the specific shape to perform supervised learning on the artificial intelligence model 110. Here, labeled data are referred to as ground truth data. The data acquisition unit 100 may input measured data to the artificial intelligence model 110 to perform supervised learning on the artificial intelligence model 110.

The artificial intelligence model 110 according to the present disclosure may include a temperature model 140 and a sensing model 150.

The temperature model 140 is an artificial intelligence model for predicting temperature. The temperature model 140 is trained to predict temperature by receiving input of the current flowing through the SMA system 120 and the voltage across the wire. Alternatively, the temperature model 140 is trained to predict temperature by receiving input of resistance or impedance values. For example, the temperature model 140 may calculate the temperature of the SMA system 120 by using the same method as a resistance temperature detector.

According to one embodiment of the present disclosure, the temperature model 140 may be trained through supervised learning by receiving temperature values measured by the sensor unit 130 as ground truth data. Here, ground truth data refers to the correct answers used for supervised training and sought to be achieved by the results output from the artificial intelligence model.

The sensing model 150 is an artificial intelligence model for predicting a generated force and a length change of the SMA with the specific shape. The sensing model 150 is trained to predict the generated force or the length change respectively by receiving the load limit, operation time, resistance or impedance of the SMA with the specific shape, and temperature values. Here, temperature values predicted by the temperature model 140 are used for temperature data.

The sensing model 150 may further receive the resistance or impedance of the wire. Here, the resistance or impedance of the wire may be input to the sensing model 150 using a skip connection. Since the temperature predicted by the temperature model 140 may not be accurate, inaccuracy may be compensated by inputting resistance or impedance of the wire through the skip connection.

The sensing model 150 may be trained through supervised learning by receiving a generated force of the SMA with the specific shape, which is measured by the sensor unit 130, as the ground truth data. Alternatively, the sensing model 150 may be trained through supervised learning by receiving a length change of the SMA with the specific shape measured by the sensor unit 130 as the ground truth data.

Various artificial intelligence models may be used for the present disclosure. For example, Convolutional Neural Network (CNN), Recurrent Neural Network (RNN), or Long Short Term Memory (LSTM) may be used as an artificial intelligence model of the present disclosure. CNN, RNN, and LSTM are introduced as examples for description; the present disclosure is not necessarily limited to the specific examples, and various other artificial intelligence models may be used. Although not shown in FIG. 1, the artificial intelligence training model 10 may further include an AC power source (not shown in the figure). An AC power source may apply AC voltage to the SMA system 120. The AC power source may change the frequency of AC voltage.

Since the AC power source applies AC voltage with a varying frequency, the number of input data used for training the artificial intelligence model may be increased.

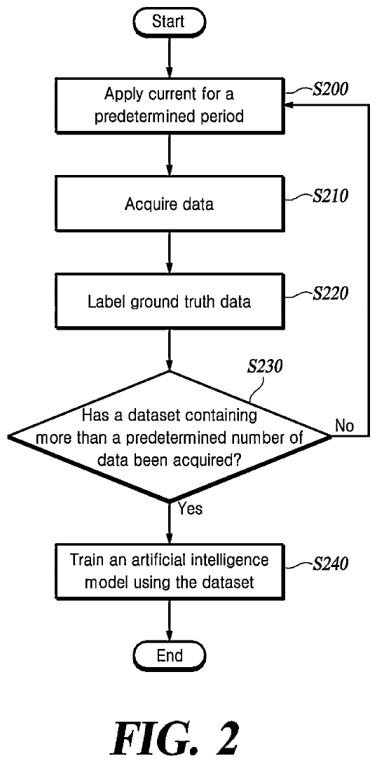

FIG. 2 is a flow diagram illustrating a process of training an artificial intelligence model according to one embodiment of the present disclosure.

Referring to FIG. 2, current is applied to the SMA system 120 of the data acquisition unit 100 for a predetermined period S200. Here, the predetermined period is determined by a control parameter controlled randomly by the data acquisition unit 100.

The data acquisition unit 100 measures the load limit, voltage, length change, generated force, and temperature using the sensor unit 130. In other words, the data acquisition unit 100 acquires a dataset based on the measured data using the sensor unit 130. Here, the data acquisition unit 100 may measure a voltage of the wire and a voltage of the SMA with a specific shape, respectively.

The data acquisition unit 100 labels the length change, generated force, and temperature from among the measured data as ground truth data S220.

The data acquisition unit 100 checks whether a dataset containing more than a predetermined number of data has been acquired S230. Here, the predetermined number refers to the number of data sufficient to train the artificial intelligence model 110. The predetermined number may be set by the user. If the number of data acquired is smaller than the predetermined number, the data acquisition unit 100 changes the control parameters and repeats the process from S200 to S220. In other words, the data acquisition unit 100 repeats the process of S200 to S220 until the predetermined number of data are acquired. If the predetermined number of data are acquired, the data acquisition unit 100 trains the artificial intelligence model 110 using the acquired dataset.

The data acquisition unit 100 inputs the dataset into the artificial intelligence model 110 and trains the artificial intelligence model 110 using the dataset S240. Among the artificial intelligence models 110, the temperature model 140 is trained to receive a voltage and a current of the wire and output a temperature. Here, the temperature model 140 may be trained through supervised learning using temperature values as the ground truth data.

Among the artificial intelligence models 110, the sensing model 150 is trained to receive the load limit, operation time, temperature and resistance or impedance of the SMA with the specific shape, and output a generated force and a length change, respectively. The artificial intelligence model 110 may additionally receive the resistance value of the wire using the skip connection. Here, the sensing model 150 may be trained through supervised learning using generated forces and length changes as the ground truth data.

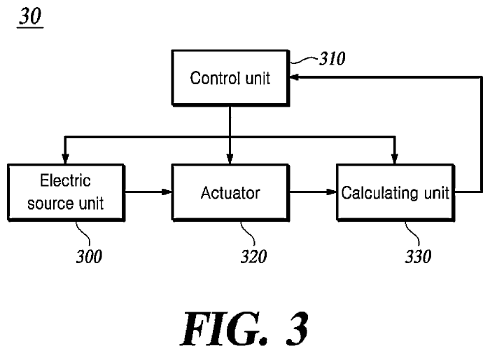

FIG. 3 is a block diagram briefly illustrating a self-sensing actuator according to one embodiment of the present disclosure.

The constituting elements of FIG. 3 represent functionally distinct elements, where at least one or more constituting elements may be implemented in an integrated form in an actual physical environment.

Referring to FIG. 3, the self-sensing actuator 30 comprises all or part of the electric source unit 300, control unit 310, actuator 320, and calculating unit 330.

The electric source unit 300 receives power from the outside and supplies power to the actuator 320. The electric source unit 300 is controlled by the control unit 310. The electric source unit 300 applies as much current or voltage as an input current value or an input voltage value to the actuator 320 according to an instruction of the control unit 310.

The control unit 310 controls the actuator 320 and the electric source unit 300. The control unit 310 may include an Arduino module, for example; however, the present disclosure is not limited to the specific example and may include all possible means capable of controlling the actuator 320 and the electric source unit 300. The control unit 310 may control the voltage applied to the actuator 320 by the electric source unit 300. Alternatively, the control unit 310 may control the current applied to the actuator 320 by the electric source unit 300.

The control unit 310 controls the operation of the actuator 320. The control unit 310 may control the operation of the actuator 320 using a control signal. For example, the control unit 310 may control the operation of the actuator 320 using a pulse width modulation (PWM) signal. The control signal is not necessarily limited to the PWM signal, and various other signals may be used for the control signal.

The control unit 310 may transmit the input voltage value or input current value to the calculating unit 330. The control unit 310 may transmit the input voltage value or input current value to the calculating unit 330 in real-time.

The actuator 320 receives a control signal from the control unit 310 and operates by receiving power from the electric source unit 300. The actuator 320 may include all or part of a voltmeter, an ammeter, and a thermometer. Here, the voltmeter, ammeter, and thermometer include all means capable of measuring voltage, current, and temperature, respectively. The actuator 320 measures all or part of the voltage, current, and temperature in real-time and transmits the measured quantities to the calculating unit 330. For example, the actuator 320 may measure the current value when the control unit 310 transmits an input voltage value to the calculating unit 330. For example, the actuator 320 may measure the voltage value when the control unit 310 transmits an input current value to the calculating unit 330.

According to one embodiment of the present disclosure, the actuator 320 may include a shape memory alloy with various shapes. For example, the actuator 320 may include a shape memory alloy with at least one of a spring shape, a zigzag shape, and a coil shape. The shape above is an example introduced for the sake of description, and the shape of the actuator 320 of the present disclosure is not limited to the specific example. The actuator 320 may include the same shape memory alloy as that included in the SMA system 120 shown in FIG. 1.

The calculating unit 330 calculates the generated force or length change of the actuator 320. The calculating unit 330 may include a pre-trained artificial intelligence model according to one embodiment of the present disclosure.

The calculating unit 330 may receive an input voltage value or an input current value from the control unit 310. The calculating unit 330 may receive a measured current value and temperature or a measured voltage value and temperature from the actuator 320. The calculating unit 330 may calculate the impedance using the input current and measured voltage values. The calculating unit 330 may calculate the impedance using the input voltage and measured current values. Alternatively, the calculating unit 330 may receive the impedance from a frequency response unit. The calculating unit 330 may input the impedance to the pre-trained artificial intelligence model.

The calculating unit 330 calculates the generated force or length change of the actuator 320 using the pre-trained artificial intelligence model 110. The calculating unit 330 may input the impedance received from the frequency response unit or the impedance calculated using received current and voltage values into the pre-trained artificial intelligence model 110. The calculating unit 330 may input the temperature calculated using the received impedance into the pre-trained artificial intelligence model 110.

The pre-trained artificial intelligence model 110 calculates the generated force or length change of the actuator 320 using the received data. The calculating unit 330 may calculate and output the generated force or length change in real-time. The calculating unit 330 may receive a current value, voltage value, temperature, and impedance at each time unit and calculate the generated force and length change. The calculating unit 330 may store received data and calculated results at predetermined time units and may use them to calculate the generated force and length change. Here, the predetermined time unit may be determined by receiving an input from the user.

The calculating unit 330 feeds back one of the generated force or length change calculated by the artificial intelligence model 110 and one of the input voltage value and input current value to the control unit 310.

Although not shown in FIG. 3, the self-sensing actuator 320 according to one embodiment of the present disclosure may further include a frequency response unit (not shown in the figure). The frequency response unit measures a frequency response according to a control signal input by the actuator 320. The frequency response unit may measure a plurality of frequency responses for each of a plurality of control signals. The frequency response unit may measure a frequency response and calculate impedance. The frequency response unit may calculate the impedance of the actuator 320 using a signal with small amplitude. Here, a signal with small amplitude may be different from the signal, voltage, or current transmitted from the electric source unit 300 and the control unit 310 to the actuator 320.

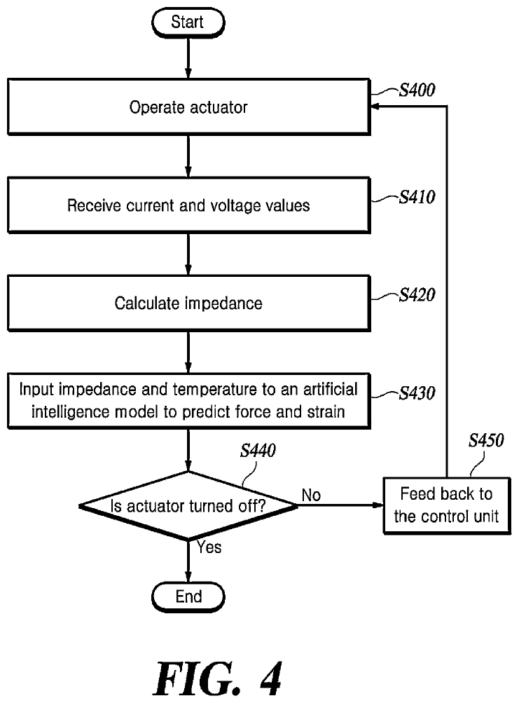

FIG. 4 is a flow diagram illustrating a self-sensing process of an actuator using a trained artificial intelligence model according to one embodiment of the present disclosure.

Referring to FIG. 4, the control unit 310 may control the electric source unit 300 and the actuator 320. The control unit 310 operates the actuator 320 by transmitting a control signal to the electric source unit 300 and the actuator 320 S400. The control unit 310 transmits an input current value or an input voltage value to the calculating unit 330.

The actuator 320 operates based on the transmitted control signal. The actuator 320 measures a voltage value or a current value and transmits the measured value to the calculating unit 330.

The calculating unit 330 receives an input current value and the measured voltage value or an input voltage value and the measured current value S410.

The calculating unit calculates impedance using the received data S420. Alternatively, the calculating unit 330 may receive impedance from the frequency response unit.

The calculating unit 330 inputs the impedance to the pre-trained artificial intelligence model 110 S430. The pre-trained artificial intelligence model 110 may calculate the temperature using the impedance. The pre-trained artificial intelligence model 110 receives the impedance and predicts the force or length change generated by the actuator 320.

The control unit 310 checks if the power of the actuator has been turned off S440. If the power of the actuator has not been turned off, the calculating unit 330 feeds back the input current value or input voltage value and the generated force or length change to the control unit 310 S450. If the power of the actuator 320 has been turned off, the control unit 310 terminates the self-sensing process.

At least part of the constituting elements described in the exemplary embodiments of the present disclosure may be implemented using a hardware element including at least one of a digital signal processor (DSP), a processor, a controller, an application-specific IC (ASIC), a programmable logic device (e.g., FPGA), and other electronic components or a combination thereof. Also, at least some of the functions or processes described in the exemplary embodiments may be implemented using software, and the software may be stored in a recording medium. At least part of the constituting elements, functions, and processes described in the exemplary embodiments of the present disclosure may be implemented through a combination of hardware and software.

A method according to exemplary embodiments of the present disclosure may be implemented using a program that may be executed in a computer and may be implemented using various types of recording media, including a magnetic storage device, an optical recording medium, and a digital storage medium.

Various techniques described in the present disclosure may be implemented using digital electronic circuitry, computer hardware, firmware, software, or combinations thereof. The implementations may be realized as a computer program tangibly embodied in a computer program product, i.e., an information carrier, e.g., a machine-readable storage device (computer-readable recording medium) or a radio signal for processing by or controlling the operation of a data processing device, e.g., a programmable processor, a computer, or a plurality of computers. Computer programs, such as the computer program(s) described above, may be written in any form of programming language, including compiled or interpreted languages, and may be written in any form including a stand-alone program or another unit suitable to be used in a module, a component, a subroutine, or a computing environment. The computer programs may be deployed for processing on one computer or multiple computers at one site or distributed across multiple sites and interconnected by a communications network.

Processors suitable for processing computer programs include, for example, both general-purpose and special-purpose microprocessors and any one or more processors of any type of digital computer. Typically, a processor will receive instructions and data from a read-only memory, a random access memory, or both. Elements of a computer may include at least one processor that executes instructions and one or more memory devices storing instructions and data. Generally, a computer may include one or more mass storage devices storing data, such as magnetic disks, magneto-optical disks, or optical disks, receive data from the mass storage devices, transmit data to the mass storage devices, or transmit and receive to and from the mass storage devices. Information carriers suitable for embodying computer program instructions and data include, for example, semiconductor memory devices; magnetic media such as hard disks, floppy disks, and magnetic tapes; optical media such as Compact Disk Read Only Memory (CD-ROM), Digital Video Disk (DVD); magneto-optical media such as floptical disk; Read Only Memory (ROM); Random Access Memory (RAM); flash memory; Erasable Programmable ROM (EPROM); and Electrically Erasable Programmable ROM (EEPROM). The processor and the memory may be supplemented by or included in special purpose logic circuitry.

The processor may run an operating system and one or more software applications that run on the operating system. Also, the processor device may access, store, manipulate, process, and generate data in response to the execution of software. For the convenience of understanding, the processor device may be described as being used as a single processor device, but it should be understood by those skilled in the art that the processor device includes multiple processing elements and/or multiple types of processing elements. For example, a processor device may include multiple processors or one processor and one controller. Also, other processing configurations, such as parallel processors, are possible.

Also, non-transitory computer-readable media may be an arbitrary available medium that may be accessed by a computer, which may include both a computer storage medium and a transmission medium.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A computer implemented method for training an artificial intelligence model for self-sensing of an actuator, the method comprising:
acquiring a dataset from a shape memory alloy system by changing control parameters for controlling the shape memory alloy system;
classifying the dataset into input data and ground truth data and labeling the dataset based on the ground truth data; and
performing supervised training on the artificial intelligence model using the labeled dataset so that the artificial intelligence model outputs a generated force of a shape memory alloy with a specific shape or a length change of the shape memory alloy with the specific shape from the input data,
wherein the shape memory alloy system includes wire and the shape memory alloy with the specific shape.

2. The method of claim 1, wherein the control parameters include a current flowing through the shape memory alloy system, an operation time of the shape memory alloy system, and a load limit attached to the shape memory alloy system,
wherein the acquiring of the dataset includes acquiring the dataset by varying the control parameters randomly within a predetermined range and inputting the randomly varied control parameters.

3. The method of claim 1, wherein the input data includes at least one or more of a voltage across each part of the shape memory alloy system, a current flowing through the shape memory alloy system, an operation time of the shape memory alloy system, and a load limit attached to the shape memory alloy system.

4. The method of claim 1, wherein the ground truth data includes a temperature of the shape memory alloy system, a generated force of the shape memory alloy system, and a length change of the shape memory alloy system.

5. The method of claim 3, wherein the performing of supervised training on the artificial intelligence model includes:
calculating a resistance or an impedance of the shape memory alloy system using the voltage across each part of the shape memory alloy system and the current flowing through the shape memory alloy system; and
performing supervised training on the artificial intelligence model so that the artificial intelligence model receives the resistance or the impedance of the shape memory alloy system and outputs at least one of a temperature, a generated force, and a length change of the shape memory alloy system.

6. The method of claim 1, wherein the shape memory alloy with the specific shape and the wire are made of the same material and have the same thickness.

7. The method of claim 1, further comprising:
applying an AC voltage to the shape memory alloy system,
wherein the control parameters further include a frequency of the AC voltage.

8. A self-sensing actuator comprising:
an actuator;
a control unit configured to control the actuator; and
a calculating unit configured to receive data from the control unit and the actuator, and calculate at least one of a generated force of the actuator and a length change of the actuator,
wherein the calculating unit includes an artificial intelligence model trained by a method of claim 1.

9. The self-sensing actuator of claim 8, wherein the actuator includes a shape memory alloy with the same shape as the shape memory alloy system.

10. The self-sensing actuator of claim 8, wherein the calculating unit feeds back at least one of the generated force of the actuator and the length change of the actuator, which are calculated by the artificial intelligence model, to the control unit.

11. The self-sensing actuator of claim 8, wherein the actuator includes a sensor capable of measuring a voltage across or a current flowing through the actuator.

12. The self-sensing actuator of claim 11, wherein the calculating unit calculates a resistance or an impedance of the actuator using one of a voltage value and a current value measured by the actuator and one of an input current value and an input voltage value applied by the control unit; and
inputs the resistance or the impedance to the artificial intelligence model.

13. An apparatus for training an artificial intelligence model comprising:
a data acquisition unit configured to acquire a dataset from a shape memory alloy system by changing control parameters for controlling the shape memory alloy system, classify the dataset into input data and ground truth data, and label the dataset based on the ground truth data; and
an artificial intelligence model trained by supervised learning to output a generated force of a shape memory alloy with a specific shape or a length change of the shape memory alloy with the specific shape from the input data, using the dataset labeled by the data acquisition unit,
wherein the shape memory alloy system includes wire and the shape memory alloy with the specific shape.

14. The apparatus of claim 13, wherein the control parameters include a current flowing through the shape memory alloy system, an operation time of the shape memory alloy system, and a load limit attached to the shape memory alloy system,
wherein the data acquisition unit acquires the dataset by varying the control parameters randomly within a predetermined range and inputting the randomly varied control parameters.

15. The apparatus of claim 13, wherein the input data includes at least one or more of a voltage across each part of the shape memory alloy system, a current flowing through the shape memory alloy system, an operation time of the shape memory alloy system, and a load limit attached to the shape memory alloy system.

16. The apparatus of claim 14, wherein the ground truth data includes a temperature of the shape memory alloy system, a generated force of the shape memory alloy system, and a length change of the shape memory alloy system.

17. The apparatus of claim 15, wherein the artificial intelligence model calculates a resistance or an impedance of the shape memory alloy system using the voltage across each part of the shape memory alloy system and the current flowing through the shape memory alloy system and is trained by supervised learning to receive the resistance or the impedance and output at least one of a temperature, a generated force, and a length change of the shape memory alloy system.

18. The apparatus of claim 13, wherein the shape memory alloy with the specific shape and the wire are made of the same material and have the same thickness.
